(19) United States
(12) Patent Application Publication
(10) Pub. No.: US 2017/0047751 A1
(43) Pub. Date: Feb. 16, 2017

(54) Charging Tower

(71) Applicant: Michael Fernandes, Toronto (CA)

(72) Inventor: Michael Fernandes, Toronto (CA)

(21) Appl. No.: 14/822,703

(22) Filed: Aug. 10, 2015

(51) Int. Cl. H02J 7/00; H02J 7/02

(52) U.S. Cl. CPC H02J 7/0044; H02J 7/0027; H02J 7/0052; H02J 7/025; H02J 2007/0062

(57) ABSTRACT

A charging tower system includes a base with a main tower housing having an electrical input, whereby said electrical input is constructed and arranged to distribute electrical power to a plurality of power systems and including one or more shelves dependent on said tower housing with at least one charging means constructed and arranged for charging an electronic device positioned on one of the shelves.

### BACKGROUND OF THE INVENTION

In today's electronic age the charging of mobile devices becomes increasingly challenging. Although various mobile charging stations exist, they each come with various shortcomings. The present invention attempts to address these shortcomings and provide a charging tower system constructed and arranged to accommodate many different charging environments.

### SUMMARY OF THE INVENTION

In one embodiment, the present invention is a free standing charging tower. It is selectively configurable with USB ports that can be singles or multiples. For example, there can be single ports or several lined up next to each other to conserve space and increase efficiency.

In one embodiment, there are one or several receptacles. The tower, in one embodiment has clamps or other structures to hold the cords in place and keep things organized.

In one embodiment, all shelves are of equal size. In another embodiment, shelves are of various sizes. Shelves are customizable and configurable for form and function, for example, they are provided as padded with a non slip and/or non scratch surface.

In one embodiment, at least one shelf is constructed and arranged with wireless and/or inductive charging built in or available.

The system optionally includes switches for lights placed on the top or where its convenient to reach.

In another embodiment, there is a foot activated on off switch for the tower and/or the lights at the base of the tower. The tower optionally includes a dimmer switch and/or switch to selectively display and/or change light bulb or LED colors.

In one embodiment, the present invention is a charging tower system, said system comprising:

a base; a main tower housing; an electrical input, whereby said electrical input is constructed and arranged to distribute electrical power to a plurality of power systems on said tower housing; one or more shelves dependent on said tower housing; at least one charging means constructed and arranged for charging an electronic device positioned on one of said shelves.

In one embodiment, the main tower is attached to said base in a fixed orientation.

In one embodiment, the main tower is attached to said base in a movable orientation.

In one embodiment, the at least one of said one or more shelves is a charging shelf constructed and arranged to wireless charge an electronic device placed on said charging shelf.

In one embodiment, the at least one of said one or more shelves is a charging shelf constructed and arranged to wireless charge an electronic device placed on said charging shelf through inductive charging.

In one embodiment, the charging means is one or more USB ports.

In one embodiment, the charging means is one or more Alternating Current (AC) outlet.

### BRIEF DESCRIPTION OF THE SEVERAL VIEWS OF THE DRAWINGS

FIG. 1 is a side view of the charging tower according to one embodiment of the present invention.

FIG. 2A is a front view of the charging tower according to one embodiment of the present invention.

FIG. 2B is an enlarged view as indicated from FIG. 2A.

FIG. 3 is a side partial cross-section view of a removable shelf according to one embodiment of the present invention.

FIG. 4 is a side partial cross-section view of a shelf according to one embodiment of the present invention.

FIG. 5 is an isometric view demonstrating a fastening tab according to one embodiment of the present invention.

FIG. 6 is a side partial cross-section view demonstrative of a U-hook fastening device according to one embodiment of the present invention.

FIG. 7 is a progressive view from FIG. 6 demonstrating the U-hook fastened into a secure position.

FIG. 8 is a side partial cross-section view of a permanent shelf according to one embodiment of the present invention.

FIG. 9 is a side partial cross-section view of a shelf with wireless charging capability according to one embodiment of the present invention.

FIG. 10 is a side partial cross-section view of a shelf with a spring clip according to one embodiment of the present invention.

FIG. 11 is a side view of one embodiment of the present invention in a vertical position.

FIG. 12 is a side view of the charging shelf according to one embodiment of the present invention.

FIG. 13 is a front view of the charging tower according to one embodiment of the present invention.

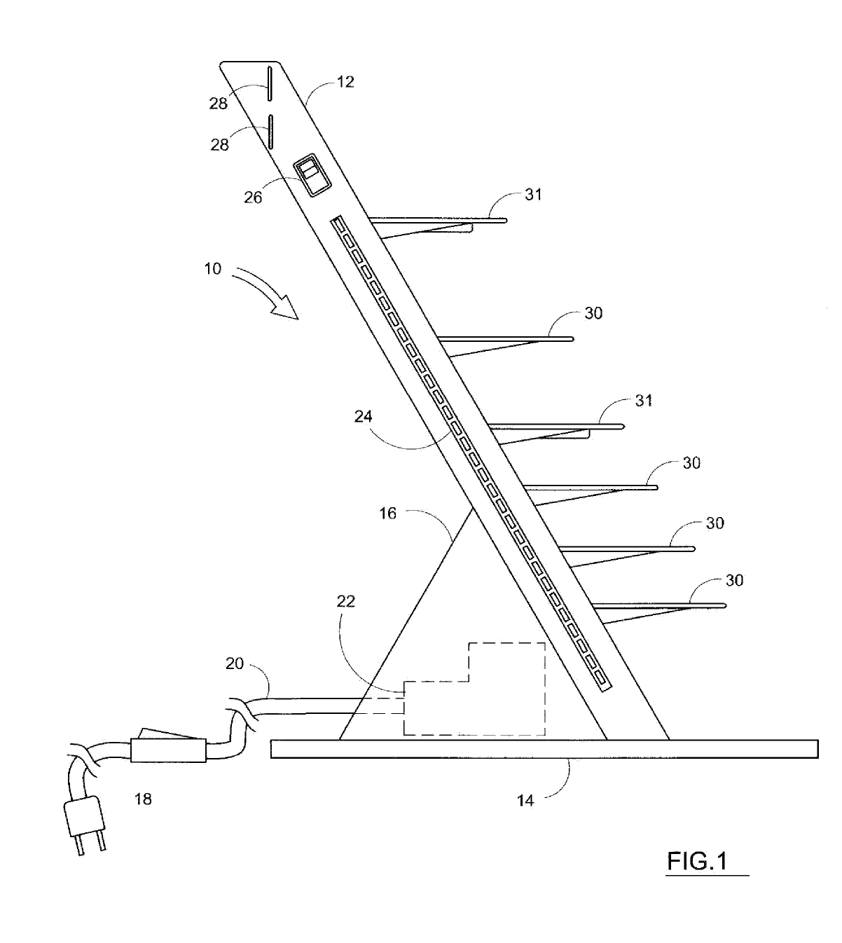

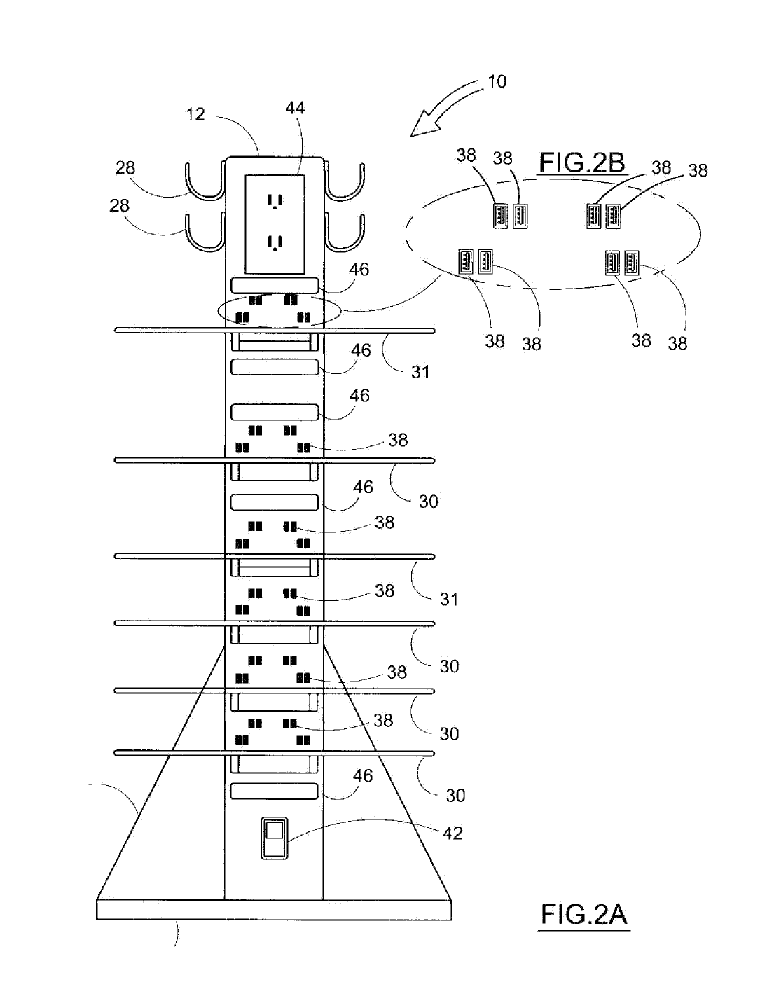

### DETAILED DESCRIPTION OF THE PREFERRED EMBODIMENT

The present invention includes a charging tower system 10 constructed and arranged for storage and/or charging of electronic devices. Tower housing 12 is supported on a tower base 14. In one embodiment, charging tower system 10 includes component housing 16 constructed and arranged to encase and secure various components therein. In one embodiment, electrical component 22 is housed within housing 16. Component 22, in one embodiment, is a combination battery/transformer with surge suppressor capability and is connected to a source of power by power cable 18.

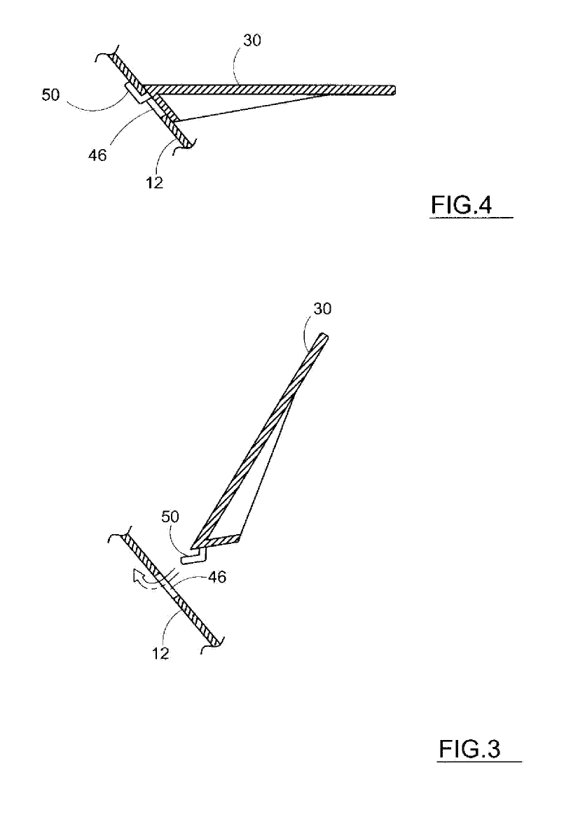

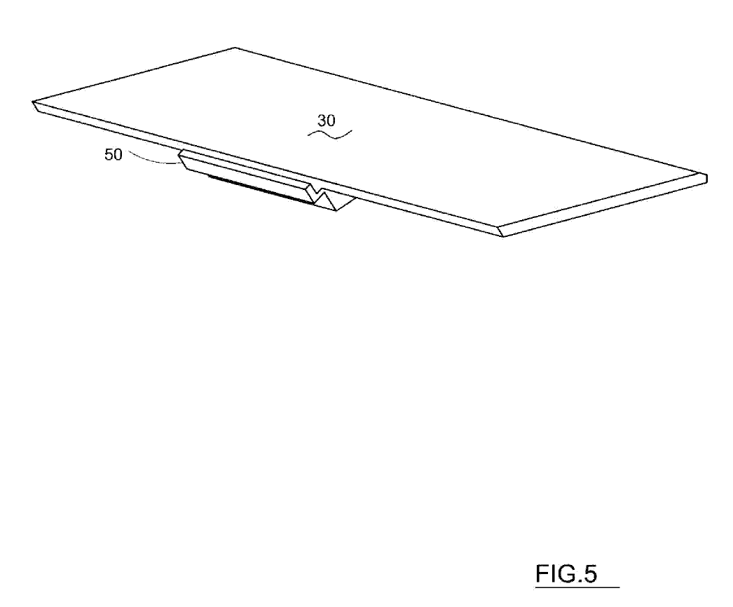

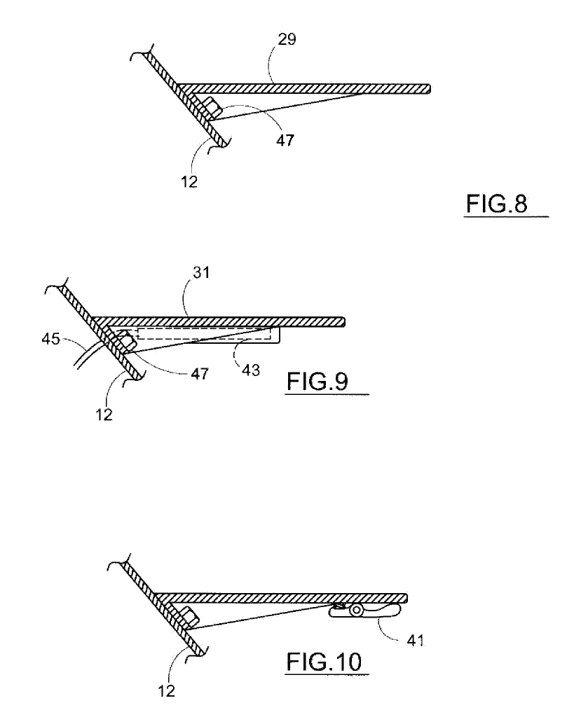

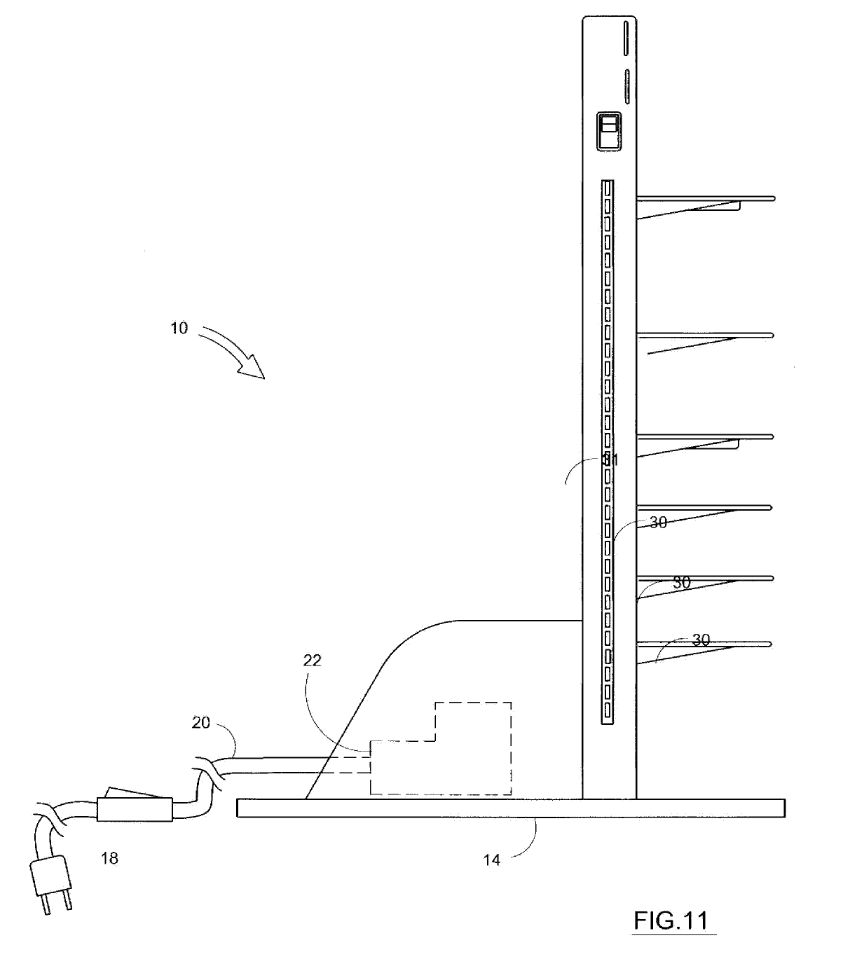

Tower housing 12 is constructed and arranged as described herein. Particular configurations can be added and can include any one or more of the components demonstrated. In one embodiment, tower housing 12 has incorporated thereon a plurality of shelves 30. In one embodiment, demonstrated in FIGS. 3 and 4, shelf 30 includes a shelf mounting tab 50 that is constructed and arranged to mate with tab attachment slot 46 in order to secure shelf 30 onto tower housing 12. In one embodiment, shelf 30 is an adjustable shelf. In another embodiment, shelves are provided, as in FIG. 8, shelf 29 being a permanently attached shelf with a permanent attachment such as mounting bolt 47, as demonstrated in FIGS. 8 and 9. Although these figures demonstrate permanent attachment with a mounting bolt, any permanent attachment is contemplated as being usable in the present invention.

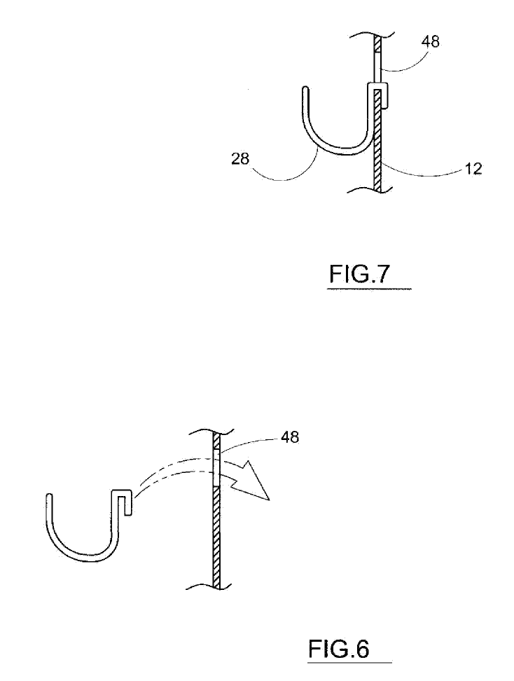

In one embodiment, tower housing 12 has one or more U-shaped hook devices 28 attached thereto. The U-shaped hook devices are constructed and arranged for hanging electrical and charging cords and other such devices. As demonstrated in FIGS. 6 and 7, U-shaped hook 28 is constructed and arranged to attach with attachment slot 48 on tower housing 12. In another embodiment, shelf 31 is included in device charging tower 10 assembly of the present invention, whereby shelf 31 is constructed and arranged for wireless charging of a device placed thereon. As demonstrated in FIG. 9, a power module 43 is positioned underneath shelf 31. Although the embodiment of the figure demonstrates power module 43 underneath shelf 31, one embodiment of the present invention provides power module 43 incorporated within shelf 31. Charging, in one embodiment, is by inductive charging. However, the present invention is not specifically limited to inductive charging, and any wireless charging is contemplated as being usable in this embodiment of the invention.

In one embodiment, tower housing 12 has incorporated thereon an on/off switch 26 that controls power to the entire charging tower assembly 10. In another embodiment, a plurality of LED lamps 24 are positioned on the side of tower housing 12, whereby said LED lamps 24 are configured to be operatively associated with various electrical components of charging tower assembly 10. For example, one or more LED lamps 24 illuminate when a particular electrical feature of charging tower assembly 10 is being used. As one non-limiting example, a mobile device is placed on shelf 31, wireless charging is initiated, and one or more LED lamps 24 are illuminated to indicate charging tower assembly 10 is in use.

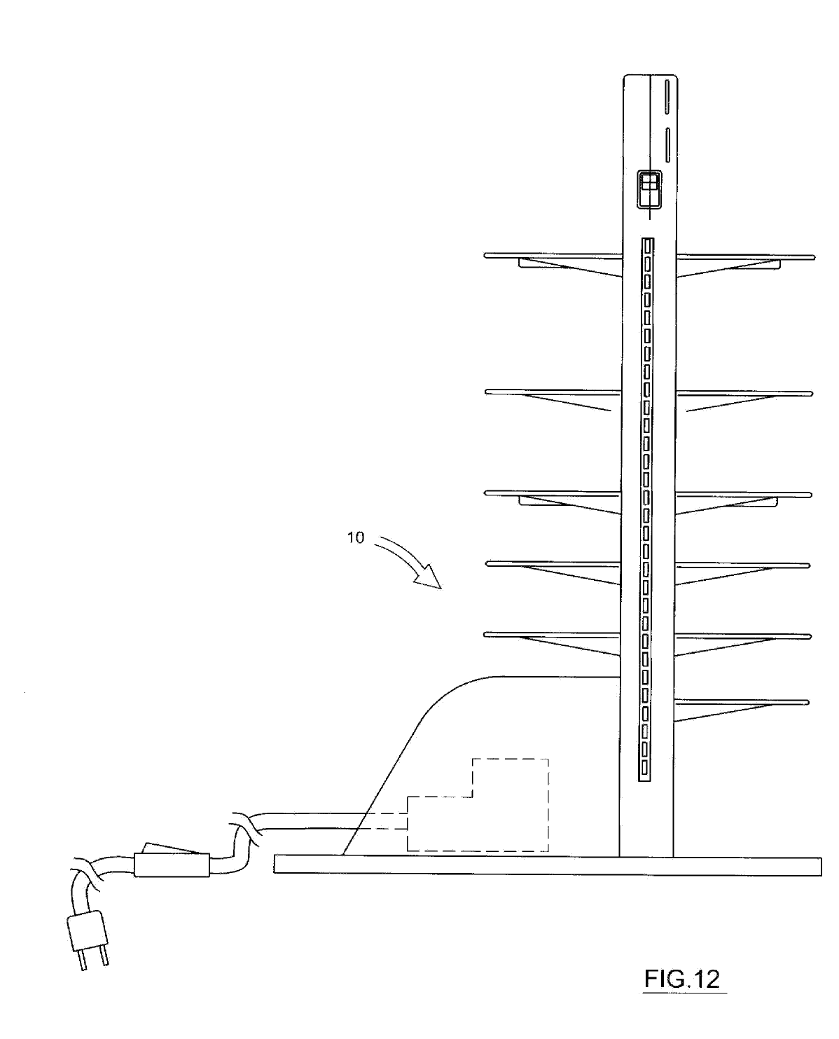

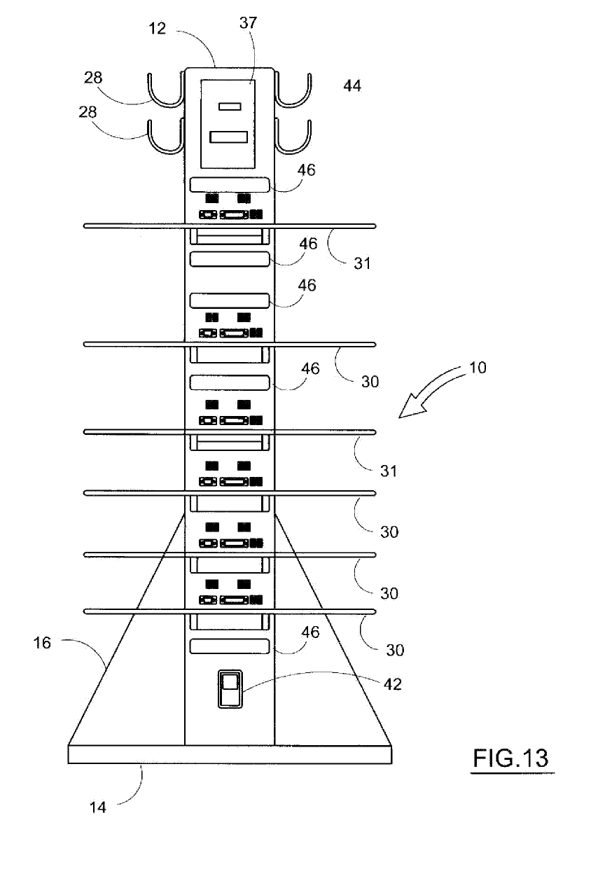

In one embodiment, electrical outlet 44 is incorporated onto tower housing 12. Tower housing 12 includes, in one embodiment, a lower on/off switch 42 that selectively provides and interrupts power to charging tower assembly 10. In one embodiment, as demonstrated in FIG. 12, tower housing 12 is perpendicular to housing base 14. In one embodiment, the angular orientation of tower housing 12 in relation to housing base 14 is selectively adjustable. In another embodiment of the present invention, one or more USB outlets are configured for charging devices on charging tower assembly 10.

In one embodiment, a console 37 is provided. Console 37 is any of a clock, USB Audio, terrestrial radio, satellite radio, Internet Radio, or combinations thereof. In one embodiment, console 37 is configured with Bluetooth transceiver compatibility.

In one embodiment, charging tower 10 is configured with additional openings providing that future upgrades in the configuration are capable. For example, an unused opening in charging tower 10 accommodates a future outlet, USB, etc. that is added at a later date.

While the invention has been described in its preferred form or embodiment with some degree of particularity, it is understood that this description has been given only by way of example and that numerous changes in the details of construction, fabrication and use, including the combination and arrangement of parts, may be made without departing from the spirit and scope of the invention.

What is claimed is:

1. A charging tower system, said system comprising:
a base; a main tower housing; an electrical input, whereby said electrical input is constructed and arranged to distribute electrical power to a plurality of power systems on said tower housing; one or more shelves dependent on said tower housing; at least one charging means constructed and arranged for charging an electronic device positioned on one of said shelves.

2. The charging tower of claim 1 wherein said main tower is attached to said base in a fixed orientation.

3. The charging tower of claim 1 wherein said main tower is attached to said base in a movable orientation.

4. The charging tower of claim 1 wherein at least one of said one or more shelves is a charging shelf constructed and arranged to wireless charge an electronic device placed on said charging shelf.

5. The charging tower of claim 1 wherein at least one of said one or more shelves is a charging shelf constructed and arranged to wireless charge an electronic device placed on said charging shelf through inductive charging.

6. The charging tower of claim 1 wherein said charging means is one or more USB ports.

7. The charging tower of claim 1 wherein said charging means is one or more Alternating Current (AC) outlet.
